(19) United States
(12) Patent Application Publication
(10) Pub. No.: US 2026/0126982 A1
(43) Pub. Date: May 7, 2026

(54) SEAMLESS CONTENT TRANSPORT ACROSS DATA REPOSITORIES IN ANALYTIC NETWORKS

(71) Applicant: SAP SE, Walldorf (DE)

(72) Inventor: Sahana Durgam Udaya, Bangalore (IN)

(21) Appl. No.: 18/940,318

(22) Filed: Nov. 7, 2024

(51) Int. Cl. G06F 8/65

(52) U.S. Cl. CPC G06F 8/65

(57) ABSTRACT

In an example embodiment, a solution is provided that splits data storage for Analytical Content Network (ACN) packages between an Analytics Cloud platform and another analytics platform, such as SAP Datasphere (DSP), from SAP SE of Walldorf, Germany. More particularly, object metadata is stored in SAC while object data itself is stored in DSP. This allows for the planning tools of SAC to be utilized efficiently based on locally stored object metadata, while extending the data limits so that large amounts of object data, stored in DSP, can be shared among tenants.

### TECHNICAL FIELD

This document generally relates to computer analytics software. More specifically, this document relates to seamless content transport across data repositories in analytic networks.

### BACKGROUND

Analytics software allows individuals and entities such as businesses to obtain various analytics content, such as summaries, predictions, models, stories, visualizations, and value-driver trees (VDTs), typically regarding the functioning of an organization. An example of analytics software is the SAP Analytics Cloud™ (SAC), from SAP SE of Walldorf, Germany, which combines business intelligence, planning, and predictive capabilities.

### BRIEF DESCRIPTION OF DRAWINGS

The present disclosure is illustrated by way of example and not limitation in the figures of the accompanying drawings, in which like references indicate similar elements.

FIG. 1 is a diagram illustrating an architecture for Analytical Content Network (ACN) in accordance with an example embodiment.

FIG. 2 is a diagram illustrating an example of a package in accordance with an example embodiment.

FIG. 3 is a block diagram illustrating a system, in accordance with an example embodiment.

FIG. 4 is a sequence diagram illustrating a method, for performing a package import process, in accordance with an example embodiment.

FIG. 5 is a sequence diagram illustrating a method, for performing a package creation process, in accordance with an example embodiment.

FIG. 6 is a flow diagram illustrating a method, in accordance with an example embodiment.

FIG. 7 is a block diagram illustrating an architecture of software, which can be installed on any one or more of the devices described above.

FIG. 8 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth to provide an understanding of various example embodiments of the present subject matter. It will be evident, however, to those skilled in the art, that various example embodiments of the present subject matter may be practiced without these specific details.

In any business intelligence/analytics platform, the analytics content plays a central role in discovering the unseen patterns in an organization. Hence, sharing of the analytics content across users is very helpful for better collaboration. Additionally, standard content templates can be reused by different users, who may then have those templates applied to their own data. The infrastructure for sharing analytics content is an Analytical Content Network (ACN). Shared SAC content is called a “package.” ACN allows for the sharing of analytics content across tenants, which leads to better collaboration. For example, analytics content can be created by a development system tenant and then shared with a quality assurance tenant for testing, before being distributed to customer tenants for use.

An enterprise can use multiple systems for storing and processing data. For example, an enterprise can use a system that stores data in a database system and provides metadata that defines how the data is stored and how the data is accessed. Analytics systems have been introduced that provide advanced analytics capabilities and improved data processing performance as compared to that provided by other systems, such as a system within which the enterprise stores and maintains its data. Such analytics systems can include cloud-based analytics systems that include an analytics engine that is executed directly within the underlying database system. Such an analytics engine can be referred to as a database (DB) analytics engine (DB-based analytics engine).

By way of non-limiting example, an example cloud-based analytics system includes SAP Analytics Cloud (SAC) provided by SAP SE of Walldorf, Germany. SAC can be described as an all-in-one platform for business intelligence, planning, and predictive analytics to support enterprise operations. In some examples, SAP SAC uses multi-dimensional services (MDS), which provide a DB-based analytics engine. SAP SAC provides requests to the MDS in a particular protocol (e.g., information access (InA) protocol), which enables more complex data analytics requests to be formulated and executed (e.g., as compared to data analytics requests submitted through the DW).

A user may operate a graphical user interface of an Analytics Cloud to create one or more models. A model is a representation of the data of an organization or segment. One type of model a user can create is an analytic model, which is used to analyze data, such as by looking for trends and anomalies. Data modeling includes data wrangling, or cleaning, the dataset, defining measures and dimensions, and enhancing the data by establishing hierarchies, setting units and currencies, and adding formulas, for instance.

A data model behind the scenes contains joined tables (a hierarchy of tables, typically). At runtime, the model executes, which causes data specified by the model to be retrieved from various data sources and stored in a database. In an example embodiment, this is an in-memory database. One example of an in-memory database is HANA™, from SAP SE of Walldorf, Germany. An in-memory database (also known as an in-memory database management system) is a type of database management system that primarily relies on main memory for computer data storage. It is contrasted with database management systems that employ a disk storage mechanism. In-memory databases are traditionally faster than disk storage databases because disk access is slower than memory access.

An SAC content user (a user who can consume or interact with content) can view all available content packages in their listing and import those packages relevant for their analytic workflows. This includes public content (templates or demo content) and private content (shared privately with them).

The packages themselves are essentially pre-built collections of dashboards, reports, data models, and other analytics content that are designed to help organizations quickly gain insights and make better decisions based on their data.

An ACN is capable of connecting to any Analytic Cloud tenant, and thus it can provision and share content into any Analytic Cloud tenant. ACN also supports a few end-user workflows. First, an Analytic Cloud content creator allows for the creation of Analytic Cloud content in the form of stories, models, dimensions, connections, and VDTs. If authorized, a user can then export this content from the Analytic Cloud tenant to ACN by creating a content package, which can contain any number of these content items. The package can then be shared with multiple tenants. Second, an Analytic Cloud content user can view all the available content packages in their listing and import those packages relevant for their analytic workflows. This includes public content (e.g., templates, demos), restricted content and private content.

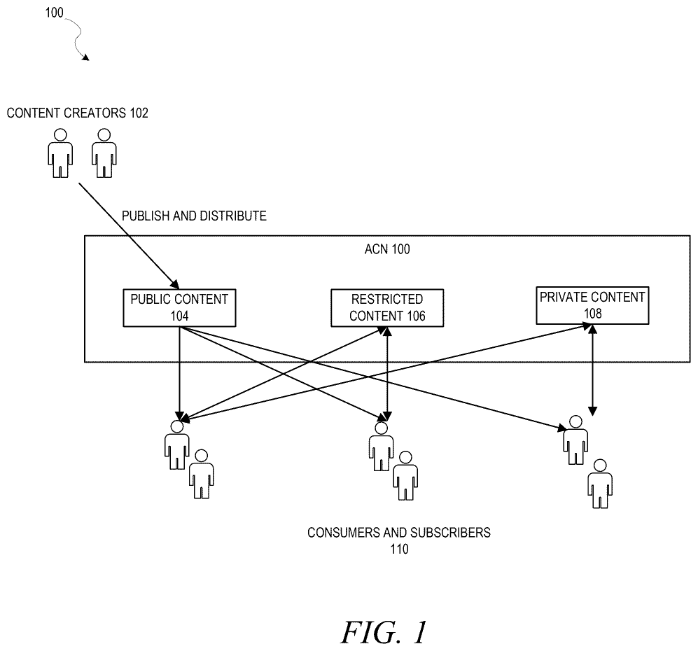

FIG. 1 is a diagram illustrating an architecture for ACN 100 in accordance with an example embodiment. Here, content creators 102 publish and distribute public content 104, restricted content 106, and private content 108. Consumers and subscribers 110 are able to pull public content 104 on demand, receive push or pull based updates of restricted content 106, and push private content 108, assuming the consumers and subscribers 110 have permission to access the corresponding content.

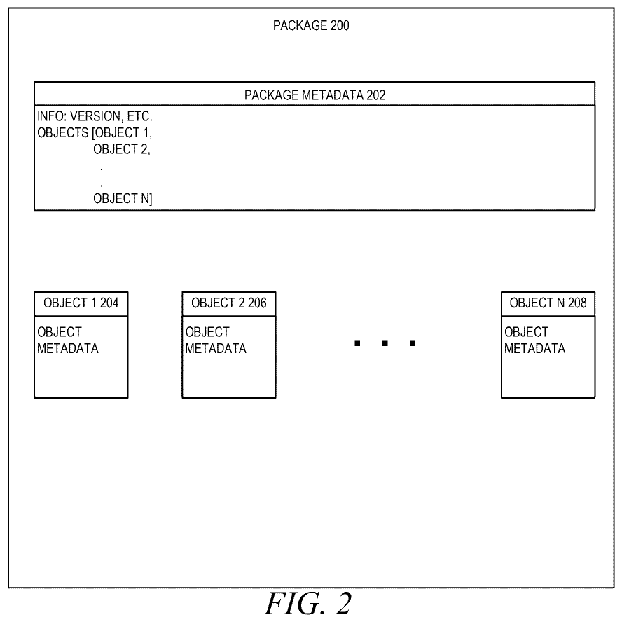

As mentioned earlier, to achieve sharing across tenants, the content may be bundled into a package. A package contains the details of each object present in the package, as well as dependency information between those objects and an overview that summarizes the content details. FIG. 2 is a diagram illustrating an example of a package 200 in accordance with an example embodiment. Package metadata 202 contains information about the package, including version information and a list of objects in the package. Each object 204, 206, 208 may then have its own metadata as well.

The following is an example of package metadata, in accordance with an example embodiment.

```
{
  *info”: {
    /* Package version information */
  }
  “objects”: [
    {
      “objectType”: “RESOURCE”,
      “objectName”: “Annual Reports”,
      “objectID”: “objectIdA”,
      “parentResID”: “PUBLIC”,
      “ancestorPath”: [ ]
    },
    {
      “objectType”: “RESOURCE”,
      “objectName”: “New Story”,
      “objectID”: “objectIdC”,
      “parentResID”: “ObjectIdB”,
      “ancestorPath”: [ ]
    },
    {
      “objectType”: “RESOURCE”,
      “objectName”: “Finance Reports”,
      “objectID”: “objectIdB”,
      “parentResID”: “ObjectIdA”,
      “ancestorPath”: [ ]
    },
```

A technical issue that arises with the use of ACN with SAC, however, is that SAC comes with a pre-configured, fixed quota, which restricts the amount of data users can acquire for planning purposes. More specifically, SAC is assigned a fixed portion of an in-memory database, such as S/4 Hana™ cloud, from SAP SE of Frankfurt, Germany. S/4 Hana™ is a modular cloud enterprise resource processing (ERP) software running with an in-memory database. An in-memory database (also known as an in-memory database management system) is a type of database management system that primarily relies on main memory for computer data storage. It is contrasted with database management systems that employ a disk storage mechanism. In-memory databases are traditionally faster than disk storage databases because disk access is slower than memory access.

Since ACN uses SAC as its data storage location, this means that the amount of data that can be shared among tenants is limited based on the memory space assigned to SAC.

In an example embodiment, a solution is provided that splits the data storage for ACN packages between SAC and another analytics platform, such as SAP Datasphere (DSP), from SAP SE of Walldorf, Germany. More particularly, object metadata is stored in SAC while object data itself is stored in DSP. This allows for the planning tools of SAC to be utilized efficiently based on locally stored object metadata, while extending the data limits so that large amounts of object data, stored in DSP, can be shared among tenants.

The object metadata may include, for example, a name and identification for the object, a type of the object (e.g., story, data model, dimension), creation/modification timestamps, owner, permissions, versioning information, data sources (e.g., data connections or models used within the objects), as well as custom properties such as categorizations.

In the proposed solution, ACN allows the user to choose either SAC or DSP as a data storage location. So, if the user chooses SAC as a data storage location, then the object metadata is stored in SAC along with the object data. If the user chooses DSP as the data storage location, then the object metadata is stored in SAC while the object data is stored in DSP.

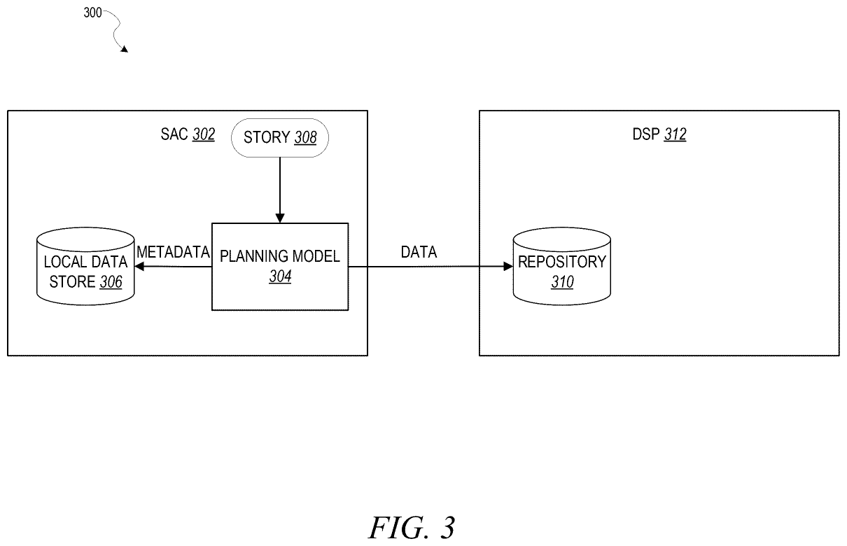

FIG. 3 is a block diagram illustrating a system 300, in accordance with an example embodiment. Here, an SAC 302 contains a planning model 304 and a local data store 306. An object, such as a story 308 consumes the planning model 304. The story itself 308 is stored remotely in a remote repository 310 on DSP 312, which supports both a DSP and a SAC model schema-story doesn't have data hence only stored in SAC. Object metadata, on the other hand, is stored in the local data store 306.

This solution provides for SAC-DSP integration, helping to leverage the powerful capabilities of both SAC (such as planning) and DSP (such as data warehousing). Now, users can push their planning data to DSP and merge this with other data sources to further strengthen their modeling, and SAC can consume these DSP HANA views to perform better visualizations.

Whenever an Analysis Cloud package is created, a summary called package metadata is formed, which contains information such as the package version, list of objects in the package, and metadata for each object, the dependencies and relationships between the objects, etc. In short, the package metadata is an overview of the contents of the package. This is bundled with the actual contents of the package as a JavaScript™ Object Notation (JSON) file and stored in a persistence layer. Before the package is persisted, details such as the name of the package, description, and the list of objects present in the package are stored in a content manager service (CMS) database.

Whenever a user clicks on a package in any of the Analysis Cloud import pages (graphical user interfaces), a call goes to the CMS to get the details of the package, such as the name, description, other metadata, and the complete list of objects that are part of the package. After checking for the permissions, CMS fetches the package details from the CMS database to form the details, which is then sent to the Analysis Cloud Extended Applications Services (XS) engine, where additional detail, whether the object already exists in the system or not, is added to the package details and returned to CMS. CMS then sends the details to the user interface.

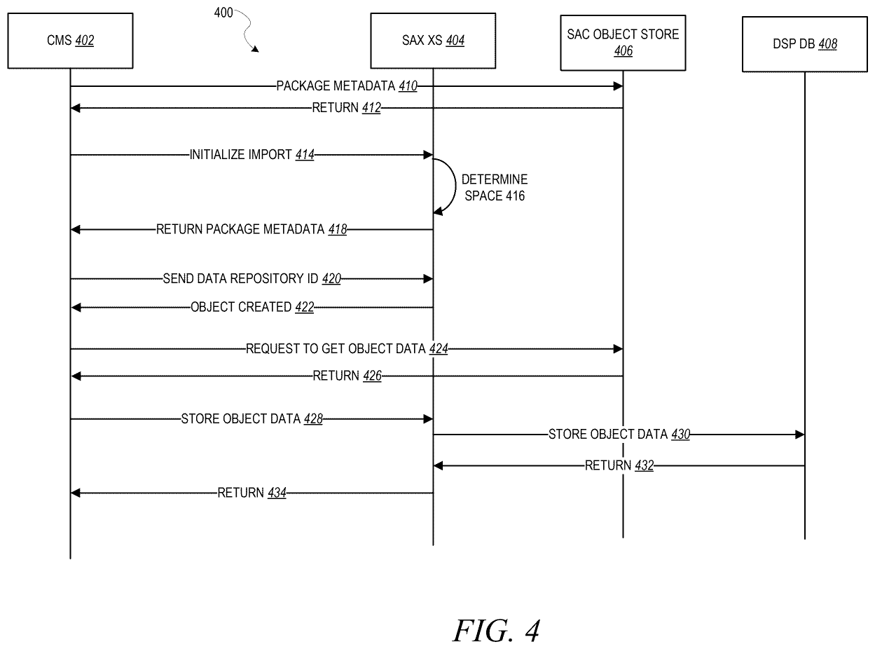

FIG. 4 is a sequence diagram illustrating a method 400, for performing a package import process, in accordance with an example embodiment. Here, the process is triggered by the user logging into a SAC tenant and clicking on a package to be imported. As mentioned earlier, the user may be given the choice to either store the object data in SAC or DSP. In this sequence diagram, it is assumed that the user has elected to store the object data in DSP.

The process utilizes a CMS 402, a SAC XS 404, a SAC object store 406, and a DSP database 408. At operation 410, the CMS 402 retrieves the package metadata from SAC object store 406. At operation 412, the SAC object store 406 fetches and return the metadata to the CMS 402.

At operation 414, an initialize import command is sent from the CMS 402 to the SAC XS 404. At operation 416, the SAC XS 404 determines the space for each object. If the object already exists, then its repository identification is obtained. If the object does not exist, then an object identification is read from the job payload. At operation 418, package metadata responsive to the import request is returned to the CMS 402.

At operation 420, the data repository identification is sent to the SAC XS 404 to store in the object. At operation 422, an object created message is sent from the SAC XS 404 to the CMS 402.

At operation 424, a request to get object data is sent from the CMS 402 to the SAC object store 406, which is returned at operation 426.

At operation 428, the CMS 402 sends a request to store the object data to the SAC XS 404. At operation 430, the SAC XS stores the object data in the DSP database 408, which sends a return response at operation 432, with the return response itself being returned to the CMS 402 at operation 434.

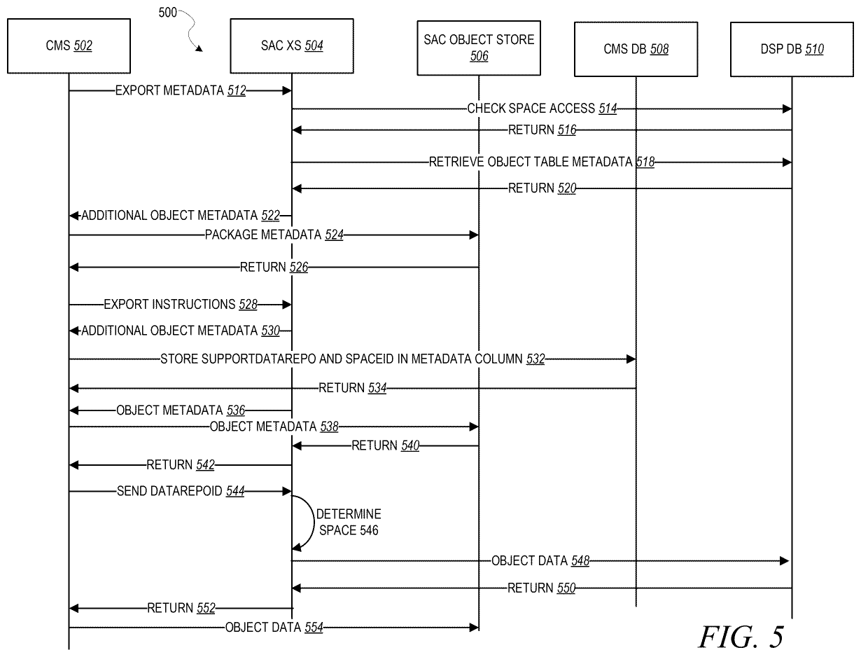

FIG. 5 is a sequence diagram illustrating a method 500, for performing a package creation process, in accordance with an example embodiment. Here, the process is triggered by the user logging into an SAC tenant and clicking on “new export” option to create a new package. The user then selects objects to be included, such as story, model, dimension, etc. As mentioned earlier, the user may be given the choice to either stored the object data in SAC or DSP during object creation. In this sequence diagram, it is assumed that the user has elected to store the object data in DSP.

The process utilizes CMS 502, SAC XS 504, an SAC object store 506, a CSM database 508, and a DSP database 510. At operation 512, the CMS 502 sends a request to export metadata to the SAC XS 504. At operation 514, the SAC XS 504 checks the space access on the DSP database 510, which responds at operation 516. At operation 518, the SAC XS 504 retrieves object table metadata from the DSP database 510, which gets it returned at operation 520. At operation 522, the object metadata is returned to the CMS 502. This object metadata includes additional metadata, such as supportDataRepo (supportDataRepository), which indicates if the objects support space selection (which will be used during import), and dataRepoId (dataRepositoryId), which indicates the details of where data is stored.

At operation 524, the CMS 502 sends the package metadata to the SAC object store 506 for storage. A return message is provided at operation 526.

At operation 528, export instructions are sent to the SAC XS 504, which returns additional object metadata at operation 530.

At operation 532, the CMS 502 stores supportDataRepo and spaceid in the metadata column of a table in the CMS database 508, which sends a return message at operation 534.

At operation 536, the CMS 502 gets the object metadata from the SAC XS 504 to create a connection. This object metadata includes dataRepoid. At operation 538, the CMS stores the object metadata in the SAC object store 506, which returns an indication that this storage was successful at operation 540, and this message is passed to the CMS 502 at operation 542.

At operation 544, dataRepoid is sent from the CMS 502 to the SAC XS 504 to create a connection. At operation 546, the SAC XS 504 checks the space access as if it is successful; at operation 548, it gets the object data from the DSP database 510. A return message is generated at operation 550, which is passed to the CMS 502 at operation 552. At operation 554, CMS 502 stores the object data directly in the SAC Object Store 506.

In view of the disclosure above, various examples are set forth below. It should be noted that one or more features of an example, taken in isolation or combination, should be considered within the disclosure of this application.

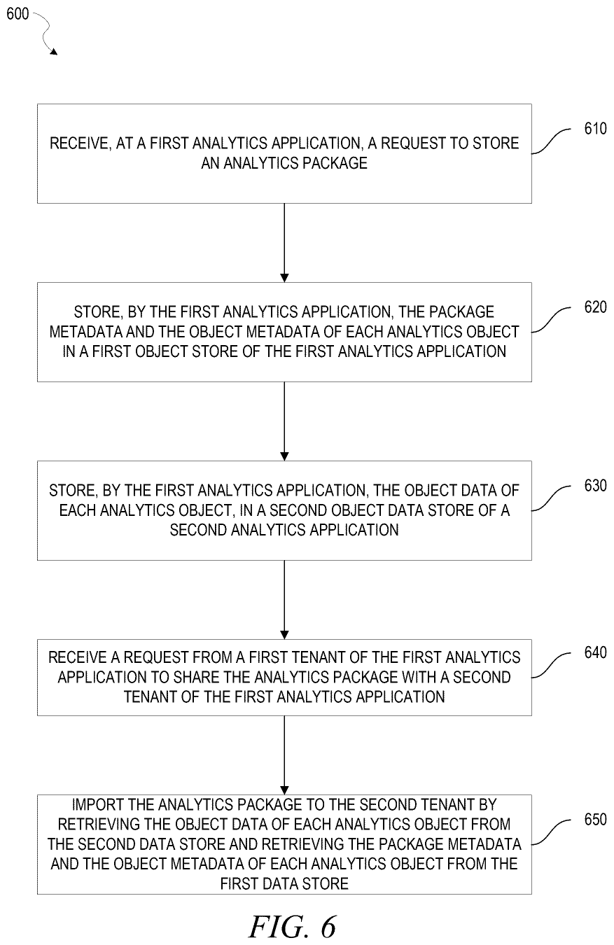

FIG. 6 is a flow diagram illustrating a method 600, in accordance with an example embodiment.

At operation 610, a request to store an analytics package is received at a first analytics application. The analytics package comprises package metadata and a plurality of analytics objects, each analytics object comprising object data and object metadata.

At operation 620, the package metadata and the object metadata of each analytics object are stored, by the first analytics application, in a first object store of the first analytics application. The first object store assigned to a fixed size space in memory of a first database.

At operation 630, the object data of each analytics object is stored in a second object data store of a second analytics application. The second object store is assigned to a dynamically sized space in memory of a second database. It should be noted that in some example embodiments the first database and the second database are the same database (e.g., HANA).

At operation 640, a request is received from a first tenant of the first analytics application to share the analytics package with a second tenant of the first analytics application.

At operation 650, the analytics package is imported to the second tenant by retrieving the object data of each analytics object from the second data store and retrieving the package metadata and the object metadata of each analytics object from the first data store.

In view of the disclosure above, various examples are set forth below. It should be noted that one or more features of an example, taken in isolation or combination, should be considered within the disclosure of this application.

Example 1 is a system comprising: at least one hardware processor; and a computer-readable medium storing instructions that, when executed by the at least one hardware processor, cause the at least one hardware processor to perform operations comprising: receiving, at a first analytics application, a request to store an analytics package, the analytics package comprising package metadata and a plurality of analytics objects, each analytics object comprising object data and object metadata; storing, by the first analytics application, the package metadata and the object metadata of each analytics object in a first object store of the first analytics application, the first object store assigned to a fixed size space in memory of a first database; storing, by the first analytics application, the object data of each analytics object, in a second object data store of a second analytics application, the second object store assigned to a dynamically-sized space in memory of a second database; receiving a request from a first tenant of the first analytics application to share the analytics package with a second tenant of the first analytics application; and importing the analytics package to the second tenant by retrieving the object data of each analytics object from the second data store and retrieving the package metadata and the object metadata of each analytics object from the first data store.

In Example 2, the subject matter of Example 1 comprises, wherein the package metadata comprises dependency information among the plurality of analytics objects.

In Example 3, the subject matter of Example 2 comprises, wherein the package metadata further comprises an overview summarizing the object data.

In Example 4, the subject matter of Examples 1-3 comprises, wherein the object metadata comprises an indication of a type of a corresponding analytics object.

In Example 5, the subject matter of Example 4 comprises, wherein the type is a story.

In Example 6, the subject matter of Examples 4-5 comprises, wherein the type is a data model.

In Example 7, the subject matter of Examples 4-6 comprise, wherein the type is a dimension.

Example 8 is a method comprising: receiving, at a first analytics application, a request to store an analytics package, the analytics package comprising package metadata and a plurality of analytics objects, each analytics object comprising object data and object metadata; storing, by the first analytics application, the package metadata and the object metadata of each analytics object in a first object store of the first analytics application, the first object store assigned to a fixed size space in memory of a first database; storing, by the first analytics application, the object data of each analytics object, in a second object data store of a second analytics application, the second object store assigned to a dynamically-sized space in memory of a second database; receiving a request from a first tenant of the first analytics application to share the analytics package with a second tenant of the first analytics application; and importing the analytics package to the second tenant by retrieving the object data of each analytics object from the second data store and retrieving the package metadata and the object metadata of each analytics object from the first data store.

In Example 9, the subject matter of Example 8 comprises, wherein the package metadata comprises dependency information among the plurality of analytics objects.

In Example 10, the subject matter of Example 9 comprises, wherein the package metadata further comprises an overview summarizing the object data.

In Example 11, the subject matter of Examples 8-10 comprises, wherein the object metadata comprises an indication of a type of a corresponding analytics object.

In Example 12, the subject matter of Example 11 comprises, wherein the type is a story.

In Example 13, the subject matter of Examples 11-12 comprises, wherein the type is a data model.

In Example 14, the subject matter of Examples 11-13 comprises, wherein the type is a dimension.

Example 15 is a non-transitory machine-readable medium storing instructions which, when executed by one or more processors, cause the one or more processors to perform operations comprising: receiving, at a first analytics application, a request to store an analytics package, the analytics package comprising package metadata and a plurality of analytics objects, each analytics object comprising object data and object metadata; storing, by the first analytics application, the package metadata and the object metadata of each analytics object in a first object store of the first analytics application, the first object store assigned to a fixed size space in memory of a first database; storing, by the first analytics application, the object data of each analytics object, in a second object data store of a second analytics application, the second object store assigned to a dynamically-sized space in memory of a second database; receiving a request from a first tenant of the first analytics application to share the analytics package with a second tenant of the first analytics application; and importing the analytics package to the second tenant by retrieving the object data of each analytics object from the second data store and retrieving the package metadata and the object metadata of each analytics object from the first data store.

In Example 16, the subject matter of Example 15 comprises, wherein the package metadata comprises dependency information among the plurality of analytics objects.

In Example 17, the subject matter of Example 16 comprises, wherein the package metadata further comprises an overview summarizing the object data.

In Example 18, the subject matter of Examples 15-17 comprises, wherein the object metadata comprises an indication of a type of a corresponding analytics object.

In Example 19, the subject matter of Example 18 comprises, wherein the type is a story.

In Example 20, the subject matter of Examples 18-19 comprises, wherein the type is a data model.

Example 21 is at least one machine-readable medium comprising instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

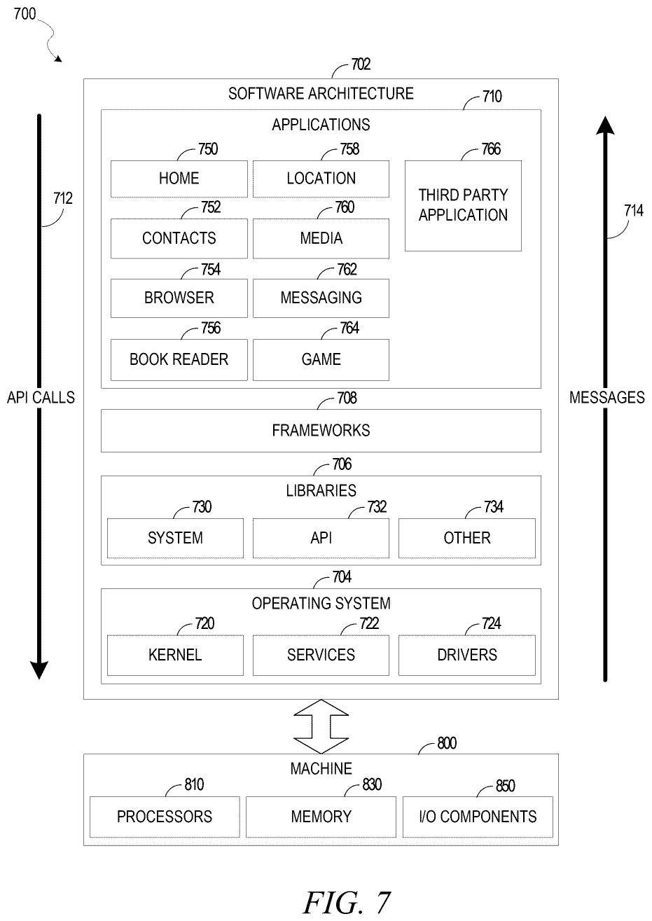

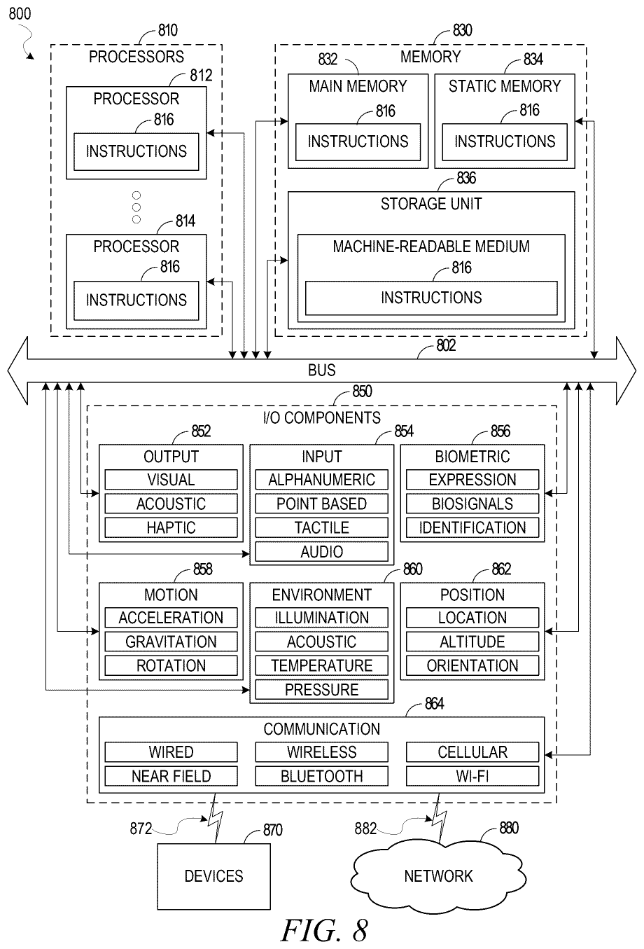

FIG. 7 is a block diagram 700 illustrating a software architecture 702, which can be installed on any one or more of the devices described above. FIG. 7 is merely a non-limiting example of a software architecture, and it will be appreciated that many other architectures can be implemented to facilitate the functionality described herein. In various embodiments, the software architecture 702 is implemented by hardware, such as a machine 800 of FIG. 8 that comprises processors 810, memory 830, and input/output (I/O) components 850. In this example architecture, the software architecture 702 can be conceptualized as a stack of layers where each layer may provide a particular functionality. For example, the software architecture 702 comprises layers such as an operating system 704, libraries 706, frameworks 708, and applications 710. Operationally, the applications 710 invoke API calls 712 through the software stack and receive messages 714 in response to the API calls 712, consistent with some embodiments.

In various implementations, the operating system 704 manages hardware resources and provides common services. The operating system 704 comprises, for example, a kernel 720, services 722, and drivers 724. The kernel 720 acts as an abstraction layer between the hardware and the other software layers, consistent with some embodiments. For example, the kernel 720 provides memory management, processor management (e.g., scheduling), component management, networking, and security settings, among other functionalities. The services 722 can provide other common services for the other software layers. The drivers 724 are responsible for controlling or interfacing with the underlying hardware. For instance, the drivers 724 can include display drivers, camera drivers, BLUETOOTH® or BLUETOOTH® Low-Energy drivers, flash memory drivers, serial communication drivers (e.g., Universal Serial Bus [USB] drivers), Wi-Fi® drivers, audio drivers, power management drivers, and so forth.

In some embodiments, the libraries 706 provide a low-level common infrastructure utilized by the applications 710. The libraries 706 can include system libraries 730 (e.g., C standard library) that can provide functions such as memory allocation functions, string manipulation functions, mathematic functions, and the like. In addition, the libraries 706 can include API libraries 732 such as media libraries (e.g., libraries to support presentation and manipulation of various media formats such as Moving Picture Experts Group-4 [MPEG4], Advanced Video Coding [H.264 or AVC], Moving Picture Experts Group Layer-3 [MP3], Advanced Audio Coding [AAC], Adaptive Multi-Rate [AMR] audio codec, Joint Photographic Experts Group [PEG or JPG], or Portable Network Graphics [PNG], graphics libraries [e.g., an OpenGL framework used to render in two-dimensional (2D) and three-dimensional (3D) in a graphic context on a display], database libraries (e.g., SQLite to provide various relational database functions), web libraries [e.g., WebKit to provide web browsing functionality]), and the like. The libraries 706 can also include a wide variety of other libraries 734 to provide many other APIs to the applications 710.

The frameworks 708 provide a high-level common infrastructure that can be utilized by applications 710. For example, the frameworks 708 provide various graphical user interface functions, high-level resource management, high-level location services, and so forth. The frameworks 708 can provide a broad spectrum of other APIs that can be utilized by the applications 710, some of which may be specific to a particular operating system 704 or platform.

In an example embodiment, the applications 710 include a home application 750, a contacts application 752, a browser application 754, a book reader application 756, a location application 758, a media application 760, a messaging application 762, a game application 764, and a broad assortment of other applications, such as a third-party application 766. The applications 710 are programs that execute functions defined in the programs. Various programming languages can be employed to create one or more of the applications 710, structured in a variety of manners, such as object-oriented programming languages (e.g., Objective-C, Java, or C++) or procedural programming languages (e.g., C or assembly language). In a specific example, the third-party application 766 (e.g., an application developed using the ANDROID™ or IOS™ software development kit [SDK] by an entity other than the vendor of the particular platform) may be mobile software running on a mobile operating system such as IOS™, ANDROID™, WINDOWS® Phone, or another mobile operating system. In this example, the third-party application 766 can invoke the API calls 712 provided by the operating system 704 to facilitate functionality described herein.

FIG. 8 illustrates a diagrammatic representation of a machine 800 in the form of a computer system within which a set of instructions may be executed for causing the machine 800 to perform any one or more of the methodologies discussed herein. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute the method 600 of FIG. 6. Additionally, or alternatively, the instructions 816 may implement FIGS. 1-6 and so forth. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example embodiment, the processors 810 (e.g., a central processing unit [CPU], a reduced instruction set computing [RISC] processor, a complex instruction set computing [CISC] processor, a graphics processing unit [GPU], a digital signal processor [DSP], an application-specific integrated circuit [ASIC], a radio-frequency integrated circuit [RFIC], another processor, or any suitable combination thereof) may include, for example, a processor 812 and a processor 814 that may execute the instructions 816. The term “processor” is intended to include multi-core processors that may comprise two or more independent processors (sometimes referred to as “cores”) that may execute instructions 816 contemporaneously. Although FIG. 8 shows multiple processors 810, the machine 800 may include a single processor 812 with a single core, a single processor 812 with multiple cores (e.g., a multi-core processor 812), multiple processors 812, 814 with a single core, multiple processors 812, 814 with multiple cores, or any combination thereof.

The memory 830 may include a main memory 832, a static memory 834, and a storage unit 836, each accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion, and the grouping is in no way limiting. In various example embodiments, the I/O components 850 may include output components 852 and input components 854. The output components 852 may include visual components (e.g., a display such as a plasma display panel [PDP], a light-emitting diode [LED] display, a liquid crystal display [LCD], a projector, or a cathode ray tube [CRT], acoustic components [e.g., speakers]), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 862 may include location sensor components (e.g., a Global Positioning System [GPS] receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., coupled via a USB).

Moreover, the communication components 864 may detect identifiers or include components operable to detect identifiers. For example, the communication components 864 may include radio-frequency identification (RFID) tag reader components, NFC smart tag detection components, optical reader components (e.g., an optical sensor to detect one-dimensional bar codes such as Universal Product Code [UPC] bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

The various memories (e.g., 830, 832, 834, and/or memory of the processor[s] 810) and/or the storage unit 836 may store one or more sets of instructions 816 and data structures (e.g., software) embodied or utilized by any one or more of the methodologies or functions described herein. These instructions (e.g., the instructions 816), when executed by the processor(s) 810, cause various operations to implement the disclosed embodiments.

As used herein, the terms “machine-storage medium,” “device-storage medium,” and “computer-storage medium” mean the same thing and may be used interchangeably. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, comprising memory internal or external to processors. Specific examples of machine-storage media, computer-storage media, and/or device-storage media include non-volatile memory, comprising by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 880 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880, may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) comprising 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., Hypertext Transfer Protocol [HTTP]). Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 816 for execution by the machine 800, and to include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
receiving, at a first analytics application, a request to store an analytics package, the analytics package comprising package metadata and a plurality of analytics objects, each analytics object comprising object data and object metadata;
storing, by the first analytics application, the package metadata and the object metadata of each analytics object in a first object store of the first analytics application, the first object store assigned to a fixed size space in memory of a first database;
storing, by the first analytics application, the object data of each analytics object, in a second object data store of a second analytics application, the second object store assigned to a dynamically sized space in memory of a second database;
receiving a request from a first tenant of the first analytics application to share the analytics package with a second tenant of the first analytics application; and
importing the analytics package to the second tenant by retrieving the object data of each analytics object from the second data store and retrieving the package metadata and the object metadata of each analytics object from the first data store.

2. The system of claim 1, wherein the package metadata comprises dependency information among the plurality of analytics objects.

3. The system of claim 2, wherein the package metadata further comprises an overview summarizing the object data.

4. The system of claim 1, wherein the object metadata comprises an indication of a type of a corresponding analytics object.

5. The system of claim 4, wherein the type is a story.

6. The system of claim 4, wherein the type is a data model.

7. The system of claim 4, wherein the type is a dimension.

8. A method comprising:
receiving, at a first analytics application, a request to store an analytics package, the analytics package comprising package metadata and a plurality of analytics objects, each analytics object comprising object data and object metadata;
storing, by the first analytics application, the package metadata and the object metadata of each analytics object in a first object store of the first analytics application, the first object store assigned to a fixed size space in memory of a first database;
storing, by the first analytics application, the object data of each analytics object, in a second object data store of a second analytics application, the second object store assigned to a dynamically sized space in memory of a second database;
receiving a request from a first tenant of the first analytics application to share the analytics package with a second tenant of the first analytics application; and
importing the analytics package to the second tenant by retrieving the object data of each analytics object from the second data store and retrieving the package metadata and the object metadata of each analytics object from the first data store.

9. The method of claim 8, wherein the package metadata comprises dependency information among the plurality of analytics objects.

10. The method of claim 9, wherein the package metadata further comprises an overview summarizing the object data.

11. The method of claim 8, wherein the object metadata comprises an indication of a type of a corresponding analytics object.

12. The method of claim 11, wherein the type is a story.

13. The method of claim 11, wherein the type is a data model.

14. The method of claim 11, wherein the type is a dimension.

15. A non-transitory machine-readable medium storing instructions which, when executed by one or more processors, cause the one or more processors to perform operations comprising:
receiving, at a first analytics application, a request to store an analytics package, the analytics package comprising package metadata and a plurality of analytics objects, each analytics object comprising object data and object metadata;
storing, by the first analytics application, the package metadata and the object metadata of each analytics object in a first object store of the first analytics application, the first object store assigned to a fixed size space in memory of a first database;
storing, by the first analytics application, the object data of each analytics object, in a second object data store of a second analytics application, the second object store assigned to a dynamically sized space in memory of a second database;
receiving a request from a first tenant of the first analytics application to share the analytics package with a second tenant of the first analytics application; and
importing the analytics package to the second tenant by retrieving the object data of each analytics object from the second data store and retrieving the package metadata and the object metadata of each analytics object from the first data store.

16. The non-transitory machine-readable medium of claim 15, wherein the package metadata comprises dependency information among the plurality of analytics objects.

17. The non-transitory machine-readable medium of claim 16, wherein the package metadata further comprises an overview summarizing the object data.

18. The non-transitory machine-readable medium of claim 15, wherein the object metadata comprises an indication of a type of a corresponding analytics object.

19. The non-transitory machine-readable medium of claim 18, wherein the type is a story.

20. The non-transitory machine-readable medium of claim 18, wherein the type is a data model.
